(19) United States
(12) Patent Application Publication
(10) Pub. No.: US 2009/0095172 A1
(43) Pub. Date: Apr. 16, 2009

(54) Pallet paint and stencil apparatus and method

(75) Inventor: Adam J. Madgar, Cortland, OH (US)

Correspondence Address: Roth,Blair,Roberts, Strasfeld & Lodge, 100 Federal Plaza East, Suite 600, YOUNGSTOWN, OH, 44503-1893, US

(73) Assignee: Millwood, Inc.

(21) Appl. No.: 11/974,089

(22) Filed: Oct. 11, 2007

(51) Int. Cl. B41M 1/12; B05D 1/02; B41L 13/04

(52) U.S. Cl. 101/118; 101/129; 427/424

(57) ABSTRACT

An apparatus and method for sequentially stenciling an image on each of a plurality of pallets uses a conveyor for transporting a first pallet along a frame to a stop location at a stenciling station. Once the first pallet is duly held at the stop location, at least one stencil image is indexed adjacent to a side-face of the pallet and sprayed through for marking the image at substantially the same region on each pallet. After the first pallet is stenciled, it exits the stenciling station, and a second pallet is transported therein and the stenciling repeated. Further, after spraying through the same stencil image for one or more stenciling passes, a clean stencil pattern is rotated in place while the prior used pattern is cleaned for reuse. The apparatus and method can also include a painting station for painting the lateral, front and rear side-faces of the pallet with an undercoat before stenciling.

### FIELD OF THE INVENTION

The present invention relates to painting and stenciling of pallets, especially wooden pallets, by passage through an automated apparatus. This invention further relates to a method for painting and stenciling pallets, in series.

### BACKGROUND OF THE INVENTION

Wooden pallets are used frequently in shipping goods and equipment. A typical shipping pallet is constructed by nailing a series of upper wooden deck panels to a supporting wooden base. The upper deck panels form a load support surface upon which goods or equipment to be transported are placed. Such pallets are generally of two types: block and stringer-type pallets. A typical block shipping pallet is shown in accompanying FIG. 1A and a typical stringer shipping pallet is shown in FIG. 1B. Both styles are meant to accommodate the tines of a forklift truck for moving about once loaded with goods or equipment for storage or transport.

To better implement wooden pallet use, a majority of such products have been standardized with respect to size and shape, at least along their 40 inch widths and 48 inch lengths (hence, their common reference as “40-48's”). While total pallet thickness or height may vary, block type pallets (FIG. 1A) include an upper deck U made from multiple cross boards, attached to an underboard that connects, at each pallet end, the supporting blocks B at two pallet comers with a center block C between. Typically, a third underboard joins a front, middle and rear center block intermediate the underboards at both pallet ends.

For better distinguishing the wooden pallets of one manufacturer from another, or of one supplier of goods or equipment from another, it is desirable to apply custom colors or paints to the product, especially in the visible areas of such pallets. In some markets, this is known as “branding your pallet.” It may be further desirable to apply logos, trademarks, warnings, messages or labels in key pallet areas that can be seen when empty, loaded and stacked, or while being used to transport goods or equipment thereon. For example, in FIG. 1A, a representative first image F (“50 lbs.” printed therein) is shown on the front corner block of that representative block-style pallet. A second, distinct image S (scripted letters stating “Co. X”) is shown on the rear block of this wooden pallet on the same side as the first image F. In FIG. 1B, a representative first image F (“25 lbs.” printed therein) is shown toward the front corner side-face of its outermost stringer sideboard. A second, distinct image S (scripted letters stating “Co. Y”) is shown on the rear corner side-face of the same stringer sideboard of this wooden pallet.

The current common practice in the industry is in the application of paints and/or stenciled legends to a pallet manually on an individual pallet-by-pallet basis; however, there are inherent deficiencies in this process. What is needed is a way to standardize and automate the process for painting then stenciling block wooden pallets quickly, efficiently and cost effectively, which this invention accomplishes. Further, with modification to the stencil spraying guns and their spraying angles relative to the pallets passing through, it would be preferable to have an apparatus that can be easily modified to paint and stencil images, including logos, trademarks, warnings, messages or labels on stringer-style pallets, as well as non-wooden and/or non-standard pallets of other shapes and styles.

Geist U.S. Pat. No. 2,395,865 shows a vintage method and apparatus for marking molded building blocks.

Mitter U.S. Pat. No. 4,195,567 shows an apparatus that enables stencil printing on a plurality of successively stacked workpieces.

Though not stenciling specific, Kapke, U.S. Pat. No. 4,829,744 illustrates an interesting “station” concept in which pallets stacked with goods are brought in for wrapping and shipping securement.

In Fattal et al., U.S. Pat. No. 4,927,486, there is disclosed a system for applying labels to pallets moving along a conveyor line. That system included a label printer and dispenser along one side of the pallet conveyor line.

Doyle et al., U.S. Pat. No. 5,873,939 uses dual track stenciling, but in the context of “screen printing” circuit boards, not pallets.

Paulk et al., U.S. Pat. No. 6,529,799 shows an apparatus for affixing tags to a stack of lumber board ends. After conveyance into the Paulk apparatus, a detector locates the lead board and, thereafter, a series of labels are stapled to the lumber ends.

And finally, Jenkins et al., U.S. Pat. No. 7,185,689 disclosed a system for applying a printed label at a particular location of packed or loaded shipping pallet.

However, nothing herein shows painting and stenciling pallets in series, with repeated precision, using an automated apparatus.

### SUMMARY OF THE INVENTION

There are several advantages to the present invention, one of which is to provide an automated station for repeatedly stenciling pallets in series. Another advantage provides a method for uniformly applying an undercoat of paint to a portion of the pallet before stenciling the custom logos, trademarks, warnings, messages or labels thereover. When applying paint as an undercoat layer to portions of a pallet being stenciled, the undercoat layer should be in a background color that visibly enhances the later sprayed stencil image. This invention allows the undercoating and/or stenciling to be accomplished in a single operation with one apparatus.

Yet another advantage provides a high speed and effective cleaning of the stencil device during the cycling of the apparatus. Still further, another advantage is to provide a complete apparatus and method that automatically accommodates the sequential operations of painting, drying and stenciling one or more images onto multiple or successive pallets, as well as regular cleaning of the stencil device for the uniform and consistent application of paint.

To achieve the foregoing and other advantages in accordance with the purpose of the invention embodied and broadly described, one embodiment of this invention preferably includes an apparatus and method for stenciling one or more images onto pallets sequentially passing through the apparatus. For stenciling, the first pallet is transported along a frame to an automated stenciling station. Once the pallet is held or duly secured therein, a first stencil image face is indexed and positioned to a particular area along at least one pallet side, for spraying through to paint that pallet side with an image in substantially the same location for each successive pallet passing through. More specifically, after the first pallet is stenciled, it is removed and a second pallet is brought in. After spraying through the stencil image face for one or more pallets, a fresh stencil image face is mechanically rotated in place and the prior stencil image face is rotated to be cleaned for reuse. For optimal efficiencies, this stenciling station and method may be preceded by a novel way for painting an undercoat and rapidly drying the vertical side-face and/or side-faces of the pallet, particularly a wooden shipping pallet, and more particularly a block-style pallet for same.

These and other features, aspects and advantages of the present invention will become better understood with reference to the following description and appended claims.

### BRIEF DESCRIPTION OF THE DRAWINGS

To describe the present preferred embodiments of this invention, reference shall be made to the accompanying drawings in which:

FIGS. 1A and 1B show a perspective view of a block and stringer pallet, respectively, showing their standard 48 inch lengths and 40 inch widths with different images stenciled to the first F and second S side comers of each pallet;

FIG. 2A is a partial perspective view of the apparatus drying and stenciling stations;

FIG. 2B is a partial perspective view of the apparatus drying and stenciling station from the opposite view shown in FIG. 2A, with a pair of pallets on the conveyor;

FIG. 3 is a side elevational view of one embodiment of apparatus painting, drying and stenciling stations;

FIG. 4 is a plan view of the apparatus stations shown in FIG. 3;

FIG. 5 is a perspective view of the dryer station with a pallet therein;

FIG. 6A is an elevational view of the output end of the stenciling station of the preferred embodiment according to this invention;

FIG. 6B is a perspective view from across the conveyor and above the stenciling station with a pallet therein;

FIG. 7 is a perspective view from the output end of the apparatus;

FIG. 8 is another perspective view from the output end of the apparatus with a pallet entering the stenciling station;

FIG. 9 is a plan view of the stenciling station with the conveyor passing therethrough;

FIG. 10 is a perspective view of a pair of stenciling devices as viewed from across the conveyor with a portion of the pallet pinch clamp from the opposite side visible;

FIG. 11 is a perspective back view of the pair of stenciling devices shown in FIG. 10 with the cover hoods hinged open for better viewing stencil positioning wheels therein;

FIG. 12 is a perspective view of a pair of open stenciling devices shown in FIGS. 10 and 11, showing a stencil sprayer head inside the positioning wheel of a forward stenciling device;

FIG. 13 is a close-up perspective view focusing on the positioning wheel interior for the rearward stenciling device shown in FIG. 12;

FIG. 14 is an elevational view focusing on a pallet pinch clamp and indexing assembly for the stenciling station of this invention; and

FIG. 15 is a side view of the pallet pinch clamp and indexing assembly in FIG. 14, showing just the pinch clamp.

### DETAILED DESCRIPTION OF PREFERRED EMBODIMENTS

The preferred embodiment herein is designed to paint an undercoat and then stencil a first image F, or other distinct logos, trademarks, warnings, messages or labels (hereinafter cumulatively referred to as a “image”) onto the forward-corner blocks B of a wooden block pallet, while simultaneously stenciling a second image S on the rear-corner blocks. As used herein, the terms “painting” and “stenciling” are meant to include, without limitation, all embodiments of marking media that may have a liquid, semi-liquid, or solid base to coat and/or cover, including, without limitation, oils, tempera, watercolors or powders.

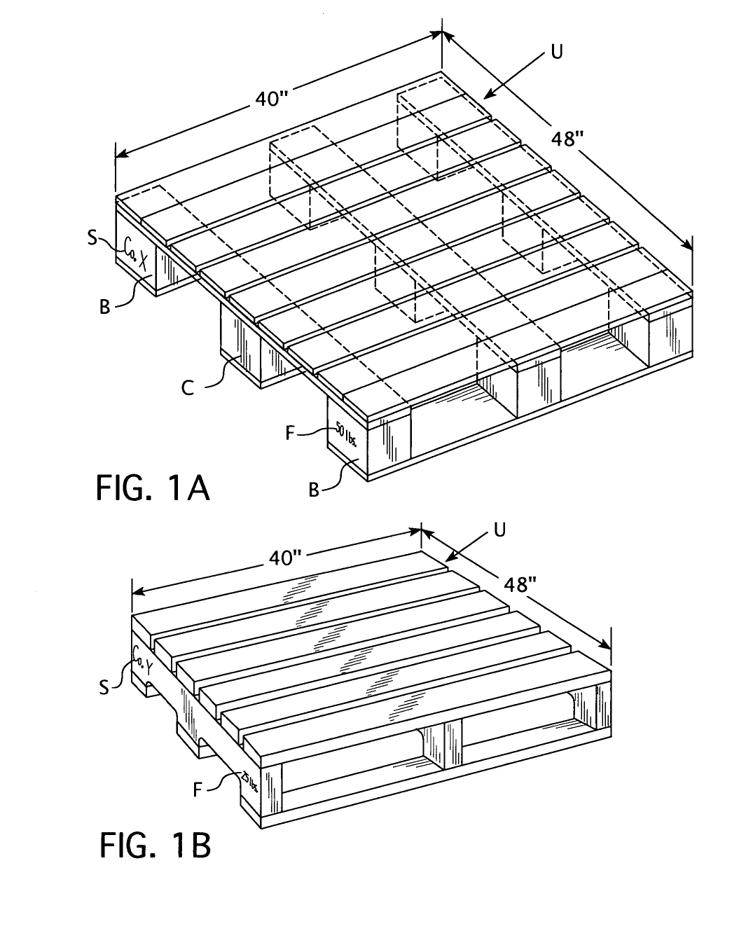

Particularly in FIG. 1A, first image F is a “50 lbs.” warning label and second image S is a symbol representing Company X, or “Co. X” as shown. With some modification, this apparatus and related method can be retrofitted to apply the same or different images to the outside of each pallet side center block C. The overall pallet configuration is not a limitation of this invention, in that this apparatus can easily be modified to rapidly and successively paint and stencil stringer-type pallets or any other uniform pallet configuration made of wood or other material. For example, FIG. 1B shows a stringer-type pallet. The outside stringer board of that pallet is shown with a stenciled first image F consisting of the warning label “25 lbs.” and the rear or second image S on that same side stringer board is a designation for another manufacturer, “Co. Y.” It is to be understood that this invention may be further modified for stenciling pallets without pre-painting an undercoat, or for stenciling a composite of multiple images in different colors in the same location on the pallet.

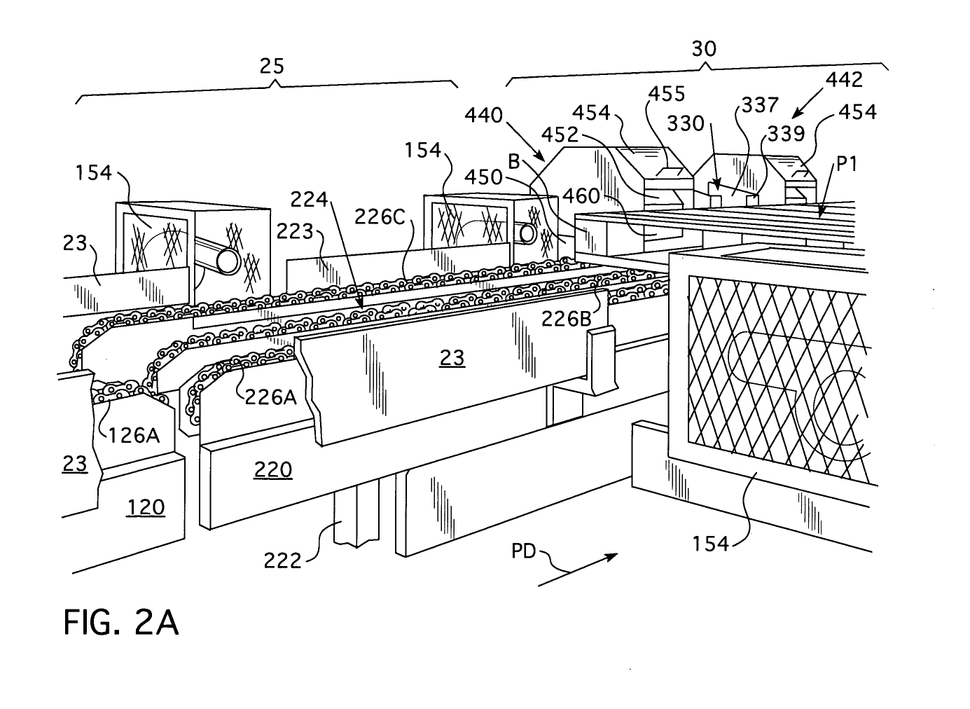

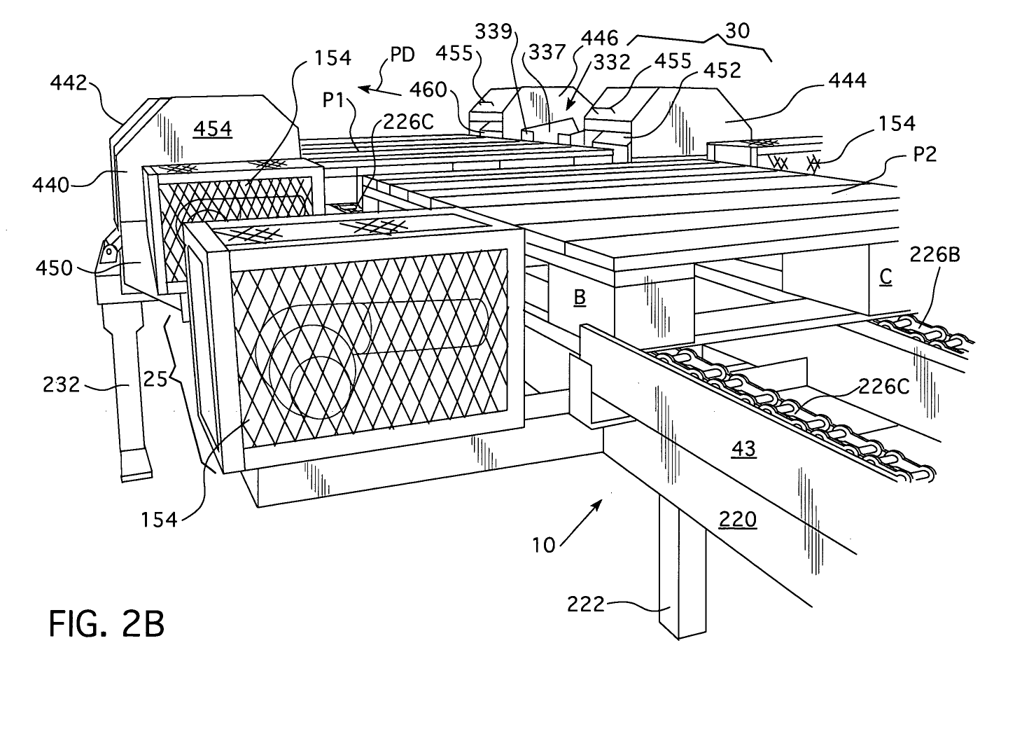

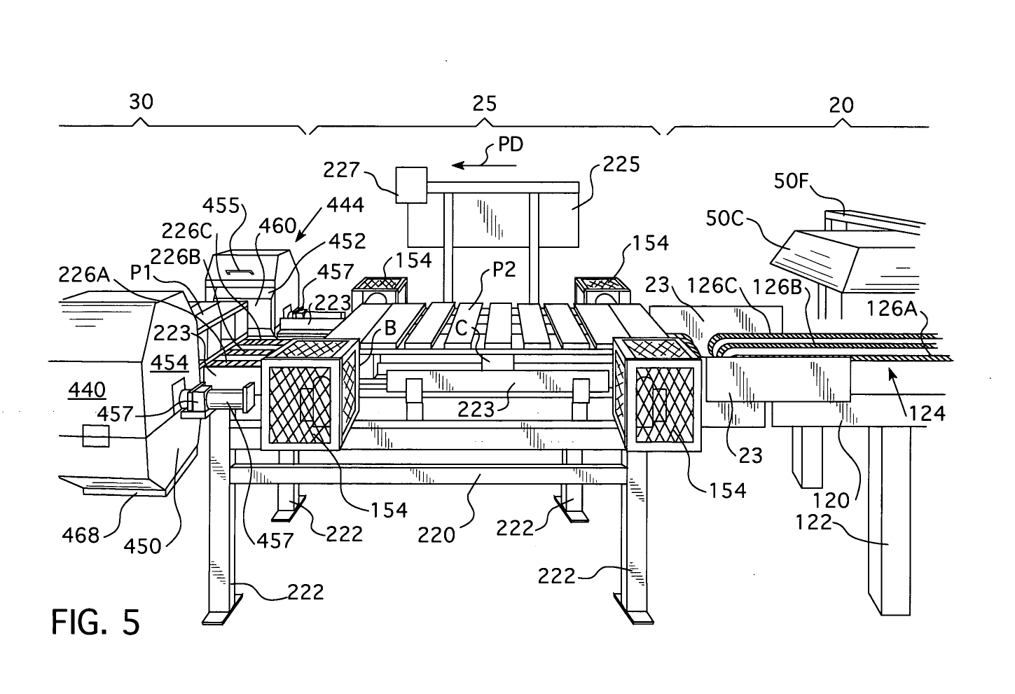

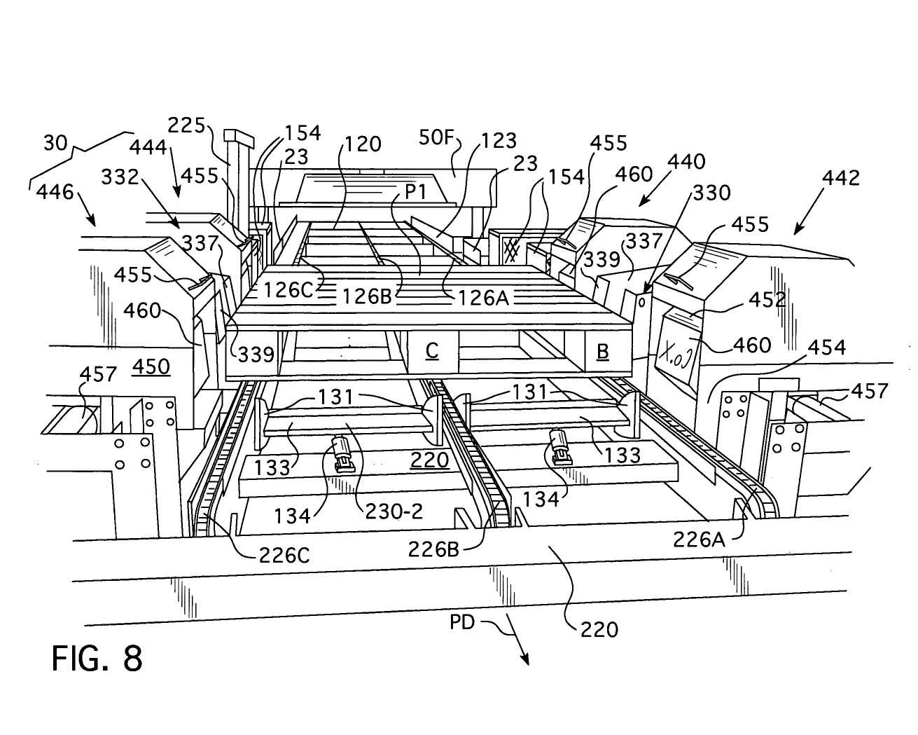

Referring to FIGS. 2A through 15, there is shown the apparatus 10 for painting and stenciling multiple pallets (P1, P2, etc.) in series. In these respective Figures, each pallet travels through the apparatus as shown by the directional arrow PD.

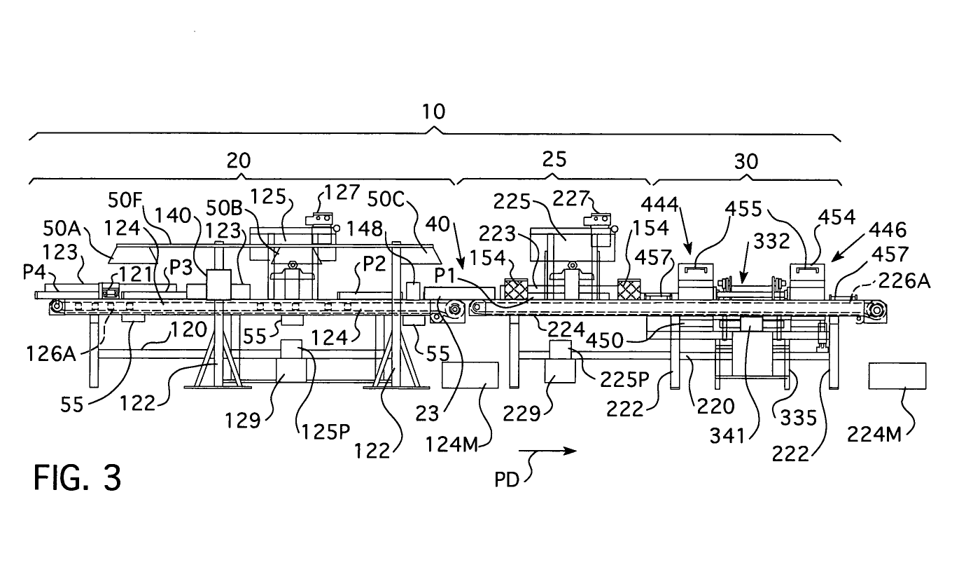

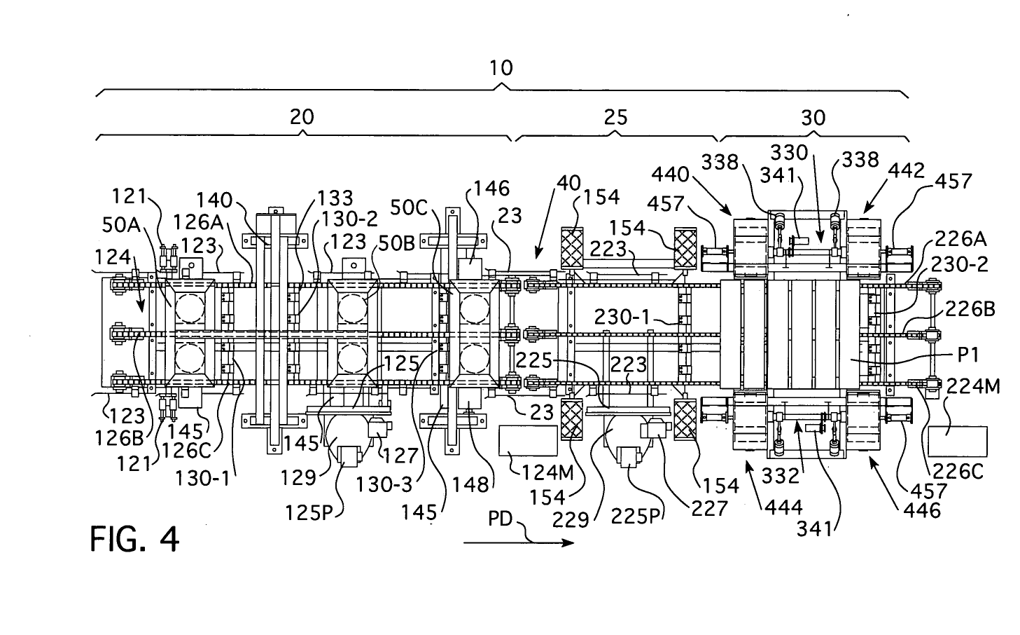

In FIGS. 3 and 4, the apparatus 10 of this preferred embodiment includes a pallet painting station 20, a dryer station 25 and a pallet stenciling station 30. These three stations are preferably joined with one or more conveyors for transporting multiple pallets into and through the respective stations, in succession. As shown in these Figures, there is a first conveyor passing through painting station 20, with an intermediate or transition region 40, before painted pallets leaving the first station of the apparatus pass along a second conveyor common to both the dryer station 25 and stenciling station 30. This dual conveyor arrangement is preferred due to transportation constraints since the long length of the apparatus would pose a problem for shipping a substantially assembled unit with a single conveyor. It is to be understood that an apparatus with one long conveyor or three smaller conveyor units may be substituted for the two conveyor apparatus shown and described herein.

Over the pallets conveyed through this apparatus, there are several overhead fans 50A, 50B and 50C, hanging from one or more fan frames 50F. These fans are intended to force any paint overspray downwardly for collecting into one or more catch basins 55 beneath each corresponding fan 50A, 50B and 50C.

As best seen in accompanying FIGS. 3 and 4, preferred pallet painting station 20 includes a main frame 120 with spaced frame supports 122 over which a paint conveyor 124 is located. Preferably, the apparatus is provided with a pair of side pinch gates 121 for proper sequencing by temporarily holding the next-in-line pallet from freely entering the automated undercoat painting operation as multiple pallets leave an adjoining pallet manufacturing unit, refurbishment apparatus, or other source of pallets.

Here, the paint conveyor 124 ends by delivering pallets to the entrance of dryer station 25 as shown. Paint conveyor 124 includes three conveyor chains 126A, 126B and 126C for mechanically transporting multiple pallets, in series, through the apparatus 10. At various side regions along the outer conveyor chains of the paint conveyor, guide rails 123 are used to keep the pallets substantially aligned. A hydraulic motor 124M drives the respective conveyor chains 126A, 126B and 126C of paint conveyor 124.

Midway along the painting station 20, there is situated a control panel 125 of gauges, regulators and the like. A paint pump 125P draws paint from a paint tank 129 where it is heated by its own paint heater 127 for maintaining the paint to be sprayed in a preferred temperature range for more consistent application, and for more efficient drying and delivery of the pallet through the overall apparatus 10.

Each pallet (P1, P2, etc.) that passes through the painting station 20 of apparatus 10 will make temporary contact with a plurality of pallet stop mechanisms 130. Such mechanisms are designed to preclude a pallet from advancing prematurely. The first of such stop mechanisms, 130-1, is found in an area of the conveyor past the first overhead fan 50A. First stop mechanism 130-1 holds a pallet from moving along the continuously rotating chains of conveyor 124 for a sufficient time to paint the front side-face of a pallet. Continuing to refer to FIG. 4, a second stop mechanism 130-2 is located along the paint conveyor at a point near the second overhead fan 50B. The second stop mechanism holds an advancing pallet for a sufficient time to paint its rearward side-face. There may be another, optional stop mechanism 130-3 inserted along the conveyor line of painting station 20, in an area preceding the third overhead fan 50C, which could serve as a temporary holding area should there be a pallet backup, where a pallet could be held before entering the pallet side painting regions of painting station 20, described in more detail hereafter.

Once each pallet in the apparatus 10 has had its front and rear vertical side-faces sprayed, it is advanced along the paint conveyor 124 through a pallet side painting area of painting station 20. There, a pair of fixed or stationary head sprayers 146 and 148 (as best seen in FIG. 4) spray along the left and right vertical pallet side-faces as the pallet is gradually conveyed past these painting head pairs. In a preferred embodiment, painting heads 146 and 148 are synchronized to deposit a single paint undercoat layer, near simultaneously, across both the left and right vertical side-faces. Should there be a backlog of pallets for any reason, the fully painted pallet that exits the side painting area of painting station 20 can be held temporarily by the third stop mechanism 130-3 until the preceding pallet has left the next successive station, dryer station 25.

More specifically, once all four vertical side-faces of a pallet are painted within painting station 20, the next stop mechanism 130-3 is contacted. Located near the ends of conveyor chains 126A, 126B and 126C, this third stop precludes the fully painted pallets from passing over transition region 40 into the dryer station 25 prematurely. In some instances, it may be preferable to install third stop mechanism 130-3 at the beginning of the dryer station 25 rather than at the end of painting station 20 due to timing and/or space constraints.

Alternately, one or more of these stop mechanisms may be replaced with, or supplemented by a pair of pistons, like those described in Griffith et al., U.S. Pat. No. 5,375,315 as “indexing pins,” laterally aligned and positioned between conveyor chains (i.e. for conveyor 124, one between chains 126A and 126B and one between 126B and 126C; for conveyor 224, one each between chains 226A and 226B and between 226B and 226C) for temporarily engaging and holding each pallet in place for sequencing in or out-of the apparatus or for performing painting, drying and/or stenciling operations thereon.

Within the second of two conveyors for the preferred embodiment of apparatus 10, as shown, there are one or more additional stop mechanisms. The first mechanism 230-1 on the second conveyor 224 temporarily holds a painted pallet in the dryer station 25 for a sufficient time to rapidly heat and dry the four corners of a pallet to be stenciled in the next station. Alternatively, apparatus 10 could be modified to locate a stop mechanism for this purpose at the end of painting station 20.

Further, a second stop mechanism 230-2 for the second conveyor 224 is used to stop and hold each pallet for indexing and stenciling within the stenciling station 30. Still further, two opposing pinch clamps 330, 332 laterally advance and engage each pallet from the sides to hold the pallet relative to the stencil image faces 460 for best stenciling results, as described in more detail below.

With reference to FIGS. 3, 4 and 8, each pallet stop mechanism 130 and 230 along the conveyors 124, 224, respectively, consists of two pallet stopping segments 133, a first between the first and second conveyor chains 126A and 126B, and the second stopping segment situated between the second and third conveyor chains 126B and 126C (placement substantially identical to that of the “indexing pins” described above). For each stopping segment 133, there is a pair of contact faces, also referred to as dog ears 131. The dog ears 131 are immediately adjacent the respective conveyor chains. In operation, the dog ears 131 are contacted by the lowermost boards of a pallet to activate the respective stop mechanism 130, 230. With the continued movement of a pallet P1 against the dog ears 131, the corresponding shaft is rotated forward. With the rotation of the dog ears 131, a proximity switch (not shown) is triggered, actuating a hydraulic piston 134 for each stopping segment 133 to rise and extend upwardly between the conveyor chains to engage, stop and hold a pallet in place for a set time. With the triggering of any given stop mechanism, corresponding method steps of this invention are commenced. For instance, a corresponding stop mechanism is preferred for holding each pallet in the respective station for painting, drying and then stenciling. Further, the stop mechanism may also be used for holding the next pallet in place, if needed, until the preceding station is cleared.

More specifically, for the stop mechanisms 130, 230 the rotation of the dog ears 131 trips a sensor (not shown) causing a given station of the apparatus 10 to initiate its sequential operation at that particular stop. Once the program has completed the assigned operation, the hydraulic pistons 134 will be deactivated and both stopping segments 133 for that particular stop mechanism 130, 230 will be lowered beneath the level of the conveyor chains by rotating forward with the force of the restarted advancing pallet. Notably, with this stop mechanism, this invention eliminates unnecessary drag and/or wear against the pallet by using the pallet to force forward rotation of the stopping segments 133 beneath the conveyor, i.e. in the same direction of the pallet movement PD through the apparatus 10.

In the front of painting station 20, stopping segments 133 of first stop mechanism 130-1 will stop and temporarily hold a single pallet in place for effecting a first painting pass thereon. Particularly, a first pallet (P1) transported through the painting station will be sprayed across its front vertical side-face using an upstream facing nozzle of a dual-spray head. Specifically, a dual-head configuration is used to more efficiently spray successive pallets passing through the apparatus. Preferably, the dual-spray head is indexed to spray between first and second pallets P1 and P2, respectively, when traveling along a dual-spray head track 140 in a first lateral direction relative to the conveyor before its return pass along dual-spray head track 140 in the opposite direction, spraying the rearward face of the second pallet P2 and the front face of a third pallet P3 subsequently fed into the painting station 20. Preferably, the dual-spray head track 140 traverses above the pallet and the dual-spray head extends downward, so as to substantially eliminate overspray from settling over the track 140 which would increase resistance, decrease the speed of travel, and ultimately require additional maintenance. Also, when coupled to one or more sensors, the dual-spray head can temporarily close a front (downstream facing) or rear (upstream facing) spray nozzle when a pallet end is not positioned in one of the dual-spray areas. This precludes wasting paint on an empty front or rear spray pass at the start or end of a pallet spraying shift.

Referring to FIGS. 3 and 4, after all four side-faces of a pallet are painted, a transition region 40 (with corresponding transition guide rails 23) will transfer each pallet from the conveyor 124 of painting station 20, consisting of chains 126A, 126B and 126C, onto the second conveyor 224, consisting of conveyor chains 226A, 226B and 226C. A preferred embodiment of apparatus 10 situates both dryer station 25 and stenciling station 30 on the same frame 220 with spaced frame supports 222 beneath. Like the first conveyor 124 through painting station 20, second conveyor 224 has its own motor mechanism 224M. The second unit commonly is wired to its own control panel 225 of gauges, regulators and the like. Like the painting station 20, a separate paint heater 227 with its own paint pump 225P is used to draw paint from a larger paint holding tank 229.

To rapidly heat and dry the freshly painted sides of each pallet, a plurality of heater/dryers, preferably forced air blowers 154, are positioned along the conveyor 224 to align with the four pallet comers in a downstream dryer station 25 of apparatus 10. With such placement, each pallet side is twice exposed to heating and drying units as the pallet advances through the pairs of laterally positioned blowers 154.

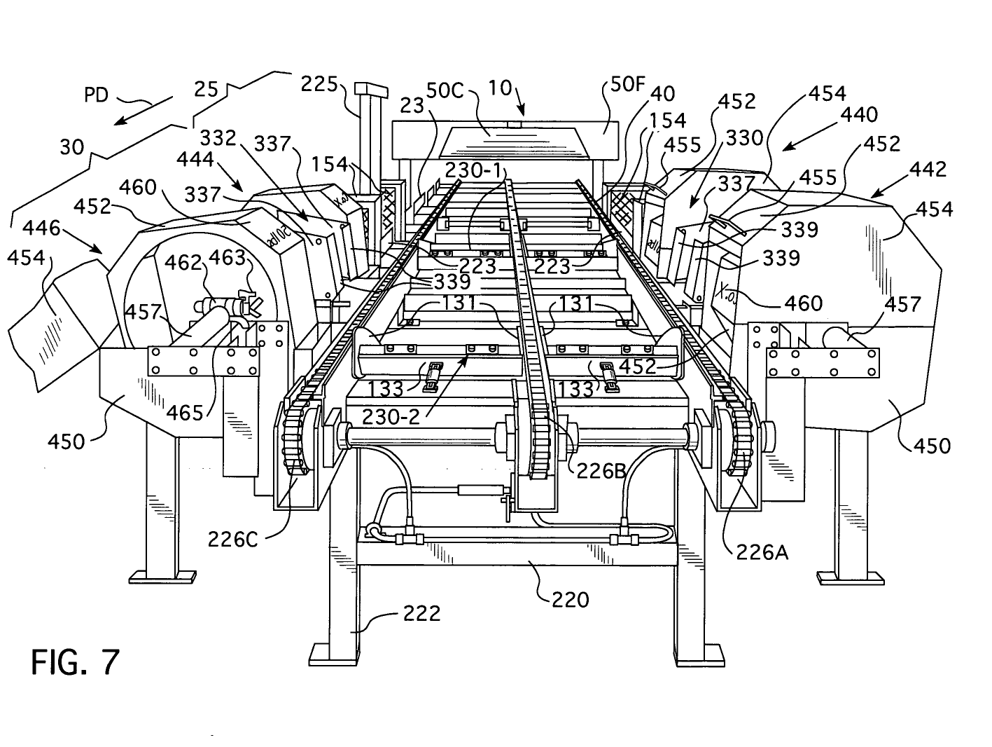

As best seen in FIGS. 7 through 10, when a pallet with fully painted sides moves along conveyor chains 226A, 226B and 226C from dryer station 25 and into stenciling station 30, the pallet abuts and is stopped by a final horizontal pallet stopping mechanism 230-2. Then, each pallet is more securely held in place over the conveyor 224 with a first pair and second pair of pallet pinch clamps 330 and 332, respectively, positioned on opposite sides of the conveyor that approach and pinch therebetween each pallet from opposing sides. Although a final pallet stopping mechanism 230-2 is preferred, if the stop mechanism 230-2 is not used in the stenciling station 30, and the pinch clamps 330, 332 are relied upon as the sole stop mechanism, a sensing device is needed to trigger the pinch clamp holding components described below.

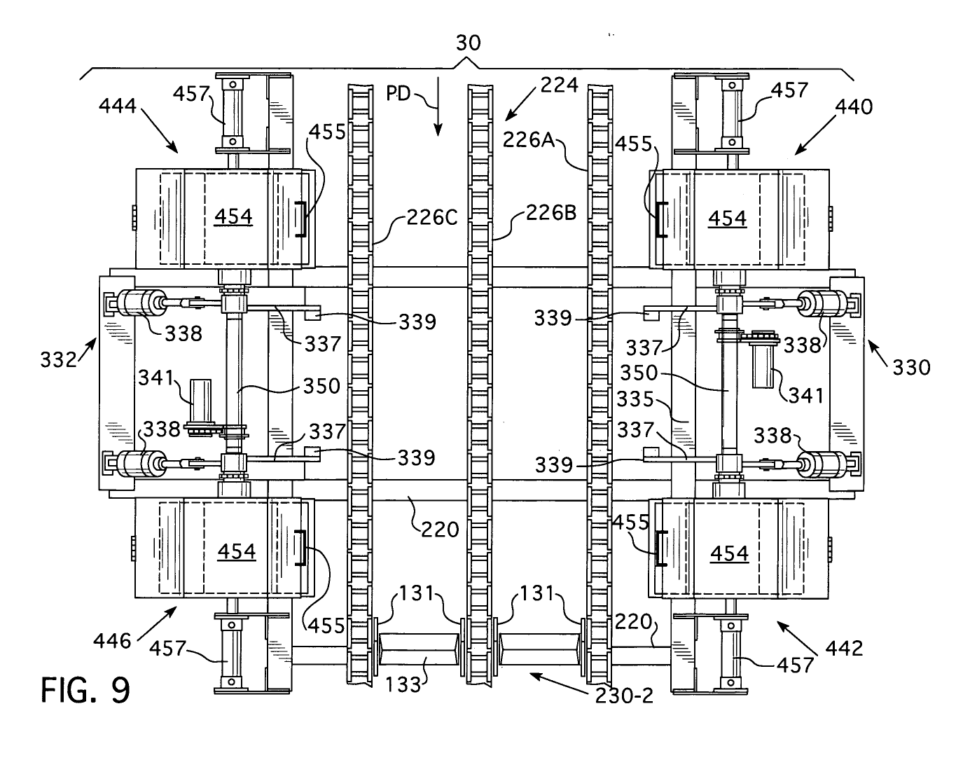

Referring to FIGS. 9, 11, 14 and 15, each opposing pinch clamp 330, 332 attaches to a corresponding shaft 350 and extend inwardly from the sides of the stenciling station 30 from its respective pinch clamp frame 335. At least two elongated pinch clamp arms 337 extend from the conveyor-facing side of each pinch clamp 330, 332 in opposing relationship. For enhancing contact of the pinch area of these clamps with each pallet passing through, pinch clamp faces 339 are used to increase the contact surface area. Should it be desirable to prevent the clamp faces 339 of pinch clamps 330, 332 from marring, scratching or otherwise marking the pallet sides, the faces may include rubberized contact bumpers. Furthermore, should pallet sidewall dimensions vary considerably, the overall lengths of clamp faces 339 may be adjustable to accommodate any given set of pallets to be painted and/or stenciled. Notably, a pair of pivotally attached hydraulic pistons 338 is used to laterally advance and retract, with reference to the conveyor 224, a corresponding shaft 350. In turn, the attached respective pinch clamps 330, 332 and stencil positioning wheels 452 (described in detail below) are reciprocated toward and away in opposing fashion from the lateral sides of each pallet during the paint operation of the stenciling station 30.

Regarding the stenciling station 30, there preferably are four indexed stenciling towers 440, 442, 444 and 446, each laterally situated to correspond to the outside face of the four corner blocks B of the pallet to be stenciled. The stenciling towers are secured to the frame 220 with spaced frame supports 222. Within the towers, paired stencil positioning wheels 452 are rotatably attached to the laterally reciprocating shaft 350, previously identified. Should a customer desire another logo, trademark, warning, message or label on the pallet center blocks C, another stenciling towers may be fitted between the shown adjacent towers subject to the spacing requirements of the pallet center blocks and the rest of stenciling station 30.

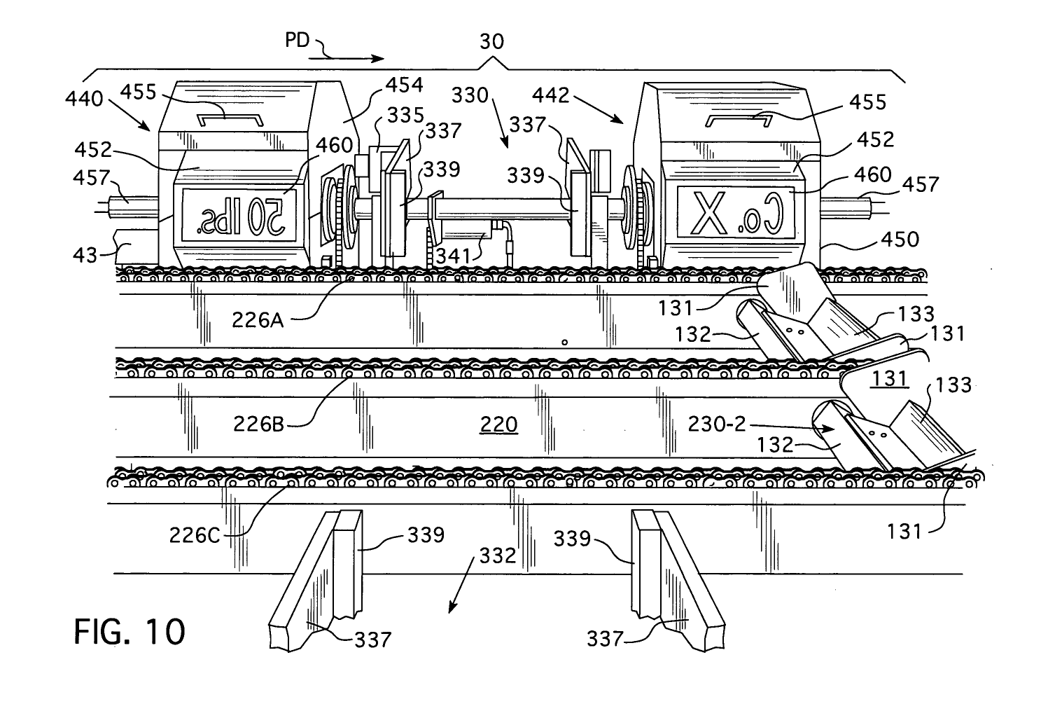

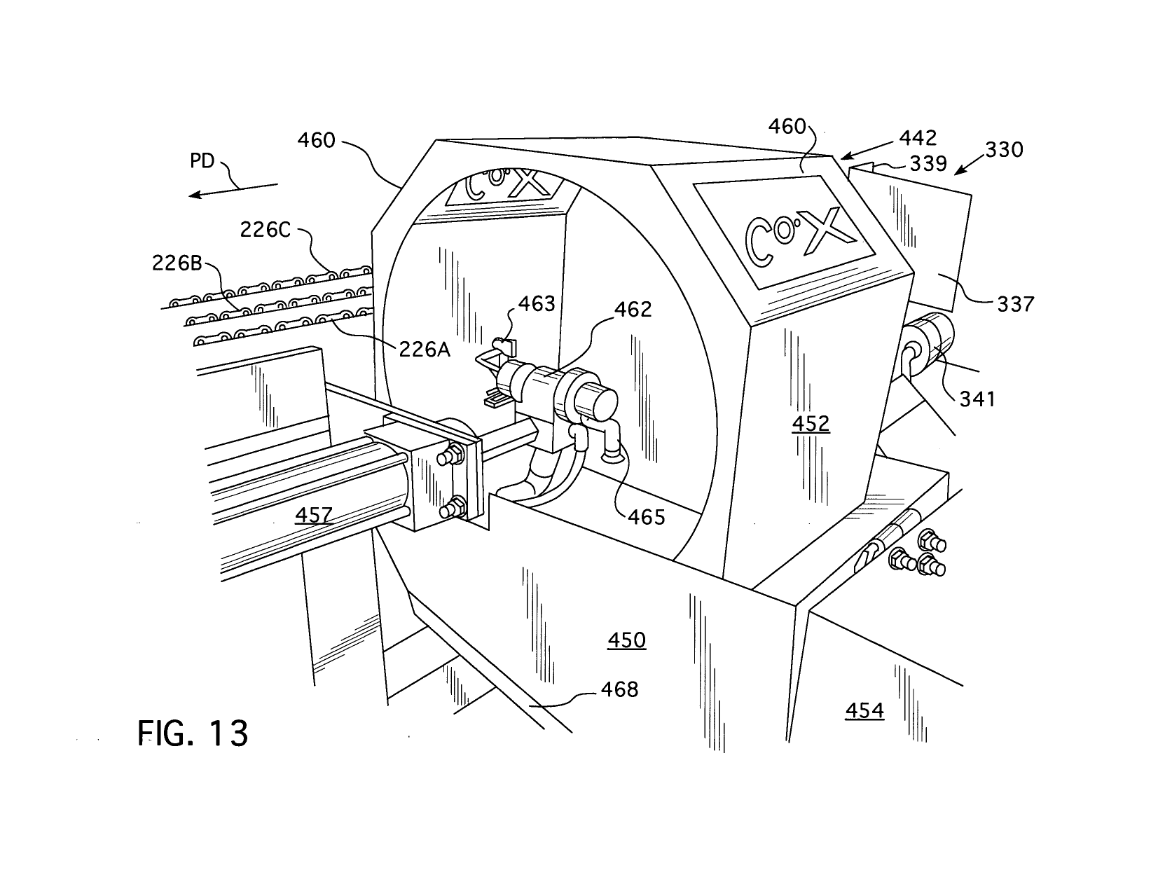

Each stenciling tower 440, 442, 444 and 446 shown in FIG. 13 includes a base component 450, the corresponding rotatable stencil positioning wheel 452, and a hinged hood 454. More specifically, each stencil positioning wheel 452 is paired with an adjacent wheel 452, as shown in FIGS. 10, 11 and 12 on the same side of conveyor 224, each rotatably attached at opposite ends to the corresponding shaft 350, i.e. pairing stenciling towers 440 with 442 and 444 with 446. Each hood 454 has a hood handle 455. On alternating face-sides of each positioning wheel 452, there is a stencil image face 460 through which paint is applied for depositing an image onto a pallet corner block B to be situated thereagainst.

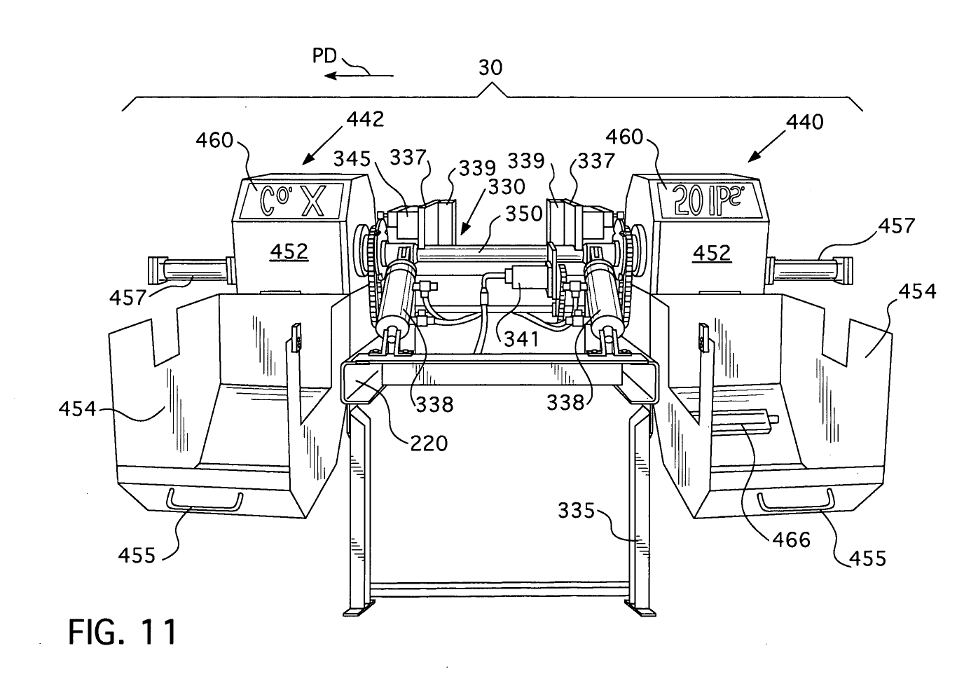

In FIGS. 11 through 13, the tower hoods 454 have been opened to better show components of these towers. These hinged hoods protect the stencil images 460 from being damaged in an industrial setting and reduce overspray emissions in the work area. The stencil positioning wheel 452 within each stenciling tower 440, 442, 444 and 446 is octagonal with four alternating stencil image faces 460. For illustrative purposes, a stencil image face with the term “Co. X” is shown, in reverse, on one stencil wheel face 460 and the adjoining tower wheel has a repeating stencil image face 460 (on the shorter sides of each wheel octagon) that states “50 lbs.”, in reverse. Alternatively, the positioning wheel 452 may have more or less than eight sides, e.g. may be hexagonal with three faces 460 or square with four faces.

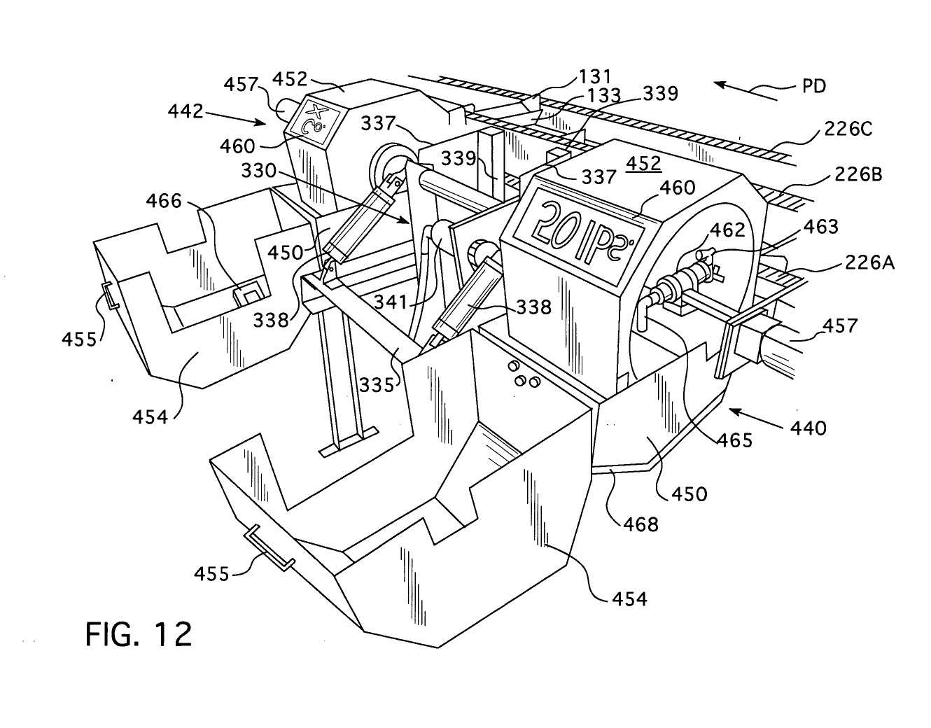

Inside the stencil positioning wheel 452 there is a paint sprayer head 462 with nozzle 463, as best seen in FIGS. 12 and 13. When stencil images are duly positioned adjacent all four corner blocks B of a properly held and aligned pallet using hydraulic pistons 338 and shaft 350, paint from sprayer head 462 passes through the stencil image face 460 for depositing that image onto each successive pallet corner block B cycled therethrough.

To best stencil the image onto each pallet corner block B, it is preferred to spray laterally across the inside of each stencil wheel face. For that reason, each sprayer head 462 within its corresponding positioning wheel 452 is mounted to an axial sprayer arm and piston 457 fixedly attached to the frame 220, so that each sprayer head 462 can piston in and out within its respective wheel, traveling completely across the stencil image face 460. The sprayer heads 462 are synchronized to spray at proximate times even though the individual images may differ.

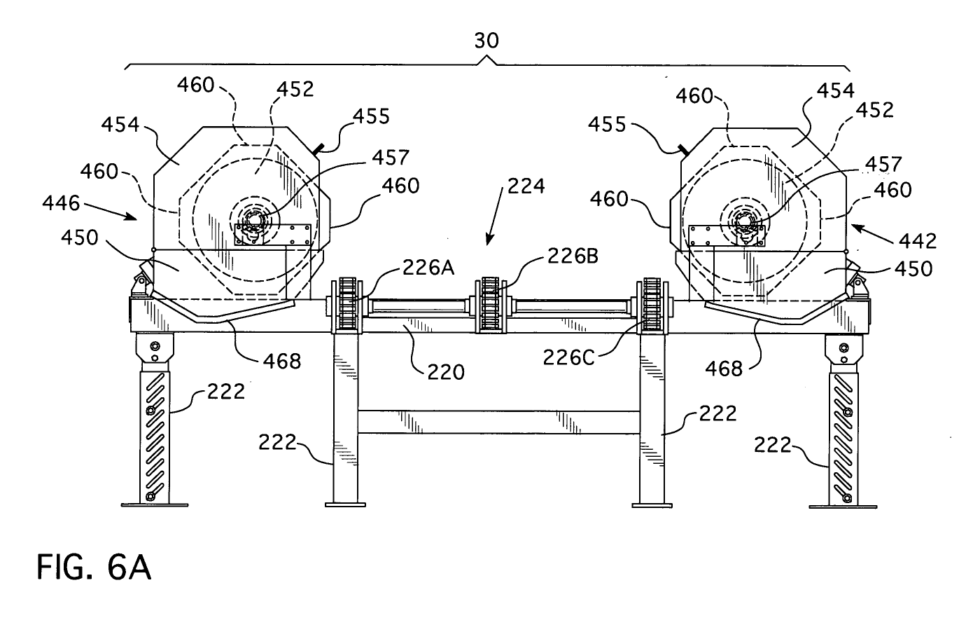

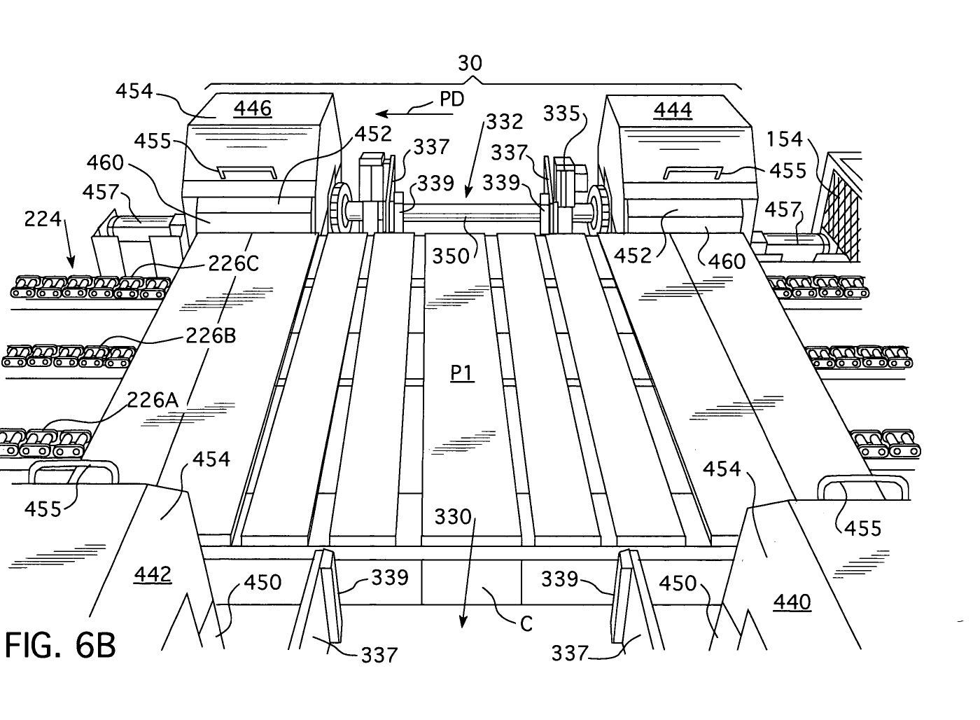

Each of these stenciling towers 440, 442, 444 and 446 is also “self-cleaning.” With two or more stencil faces 460 on each positioning wheel 452 (four are shown), a first stencil face 460 can be used to deposit the same image onto multiple successive pallets (P1, P2, etc.) before the corresponding stenciling face is cycled by rotating each positioning wheel 452 to a cleaning position in the tower proper. More specifically, rather than risk smearing of images or blurring of letters by spraying too many times through the same stencil image face 460, the positioning wheels 452 of each stenciling tower are designed to periodically rotate (either based on time, or the number of pallets sprayed) to the next clean stencil image face 460 on the wheel. In doing so, the previously used stencil image face 460 is rotated downwardly where a pressurized spray of water, or other cleaning liquid, is forced from water nozzle 465 for washing and flushing out paint residue, dirt and/or other debris that might otherwise clog the cutout portions in the stencil image face 460. The water nozzle 465 is pivotally attached to the same axial arm and piston 457 as sprayer head 462, so nozzle 465 travels with head 462 across the full stencil image face 460 being washed, so that stencil image face 460 is being cleaned at the same time the pallet blocks are being painted for stenciling by sprayer head 462. The amount of spray water used for each cleaning can be adjusted based on program settings. Preferably, waste water from spray washing the stencil image faces 460 in their respective towers is collected in a sloped lower catch basin 468 for drainage, best seen in FIG. 6A.

After indexing to the third stencil image face 460, the previously used but now water-cleaned stencil image face 460 on positioning wheel 452 may be further treated with an air knife 466. Located in the top of certain hinged hoods 454, as best seen in FIG. 11, the air knife 466 emits high pressure air to provide supplemental cleaning and drying of stencil face images as needed.

Therefore, considering the entire indexing sequence in a three-stencil image face configuration, when the second stencil face 460 has completed its painting cycle on positioning wheel 452, it is rotated down for cleaning and the next (third) face is indexed into place for continuing to apply the same stencil image 460 onto several more successive pallet corner blocks. At the same time, the previously cleaned and washed (first) stencil image face 460 will be rotated once more around positioning wheel 452 where it can be dried, naturally or with high pressure air, before being rotated once more for reuse to stencil its image on another set of successive painted pallets. During the complete cleaning process, the sprayer head 462 continues painting through a subsequently indexed stencil image face 460 on the stencil positioning wheel 452.

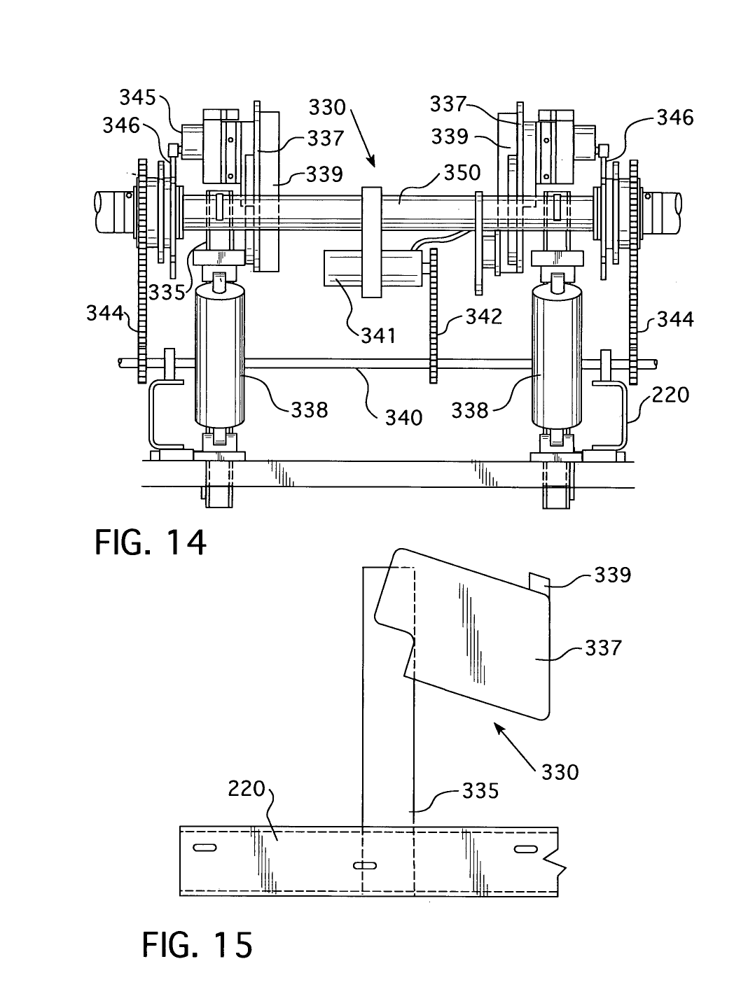

Referring to FIG. 14 to best describe the indexing of the stencil positioning wheels, a index motor 341 drives chain 342 which rotates axle 340 and, in turn, drives chains 344 to rotate the stencil positioning wheels 452 of paired adjacent stenciling towers, i.e. 440 with 442 and 444 with 446, rotatably attached to the corresponding fixed shaft 350. An indexing follower 345 is used to control index motor 341, and in turn stencil positioning wheels 452, as the indexing follower 345 engages grooves located along the perimeter of an indexer wheel 346. The grooves along the indexer wheel 346 are properly positioned to align with the positioning of the multiple stencil image faces 460 of each rotatable stencil positioning wheel 452 described above. To index a new stencil image face 460 within the stenciling towers, i.e. 440 with 442 and 444 with 446, the corresponding index motor 341 on each side of the conveyor 224 is activated to drive the paired stencil position wheels 452 about their axis until the indexing follower 345 engages the next in order index groove along the indexer wheel 346. At which point, the index motor stops and the painting, washing and drying operations commence again.

Once the stenciled images have been painted on appropriate corner blocks B, each pallet is released by retracting hydraulic pistons 338, and, in turn, corresponding pinch clamps 330, 332, and disengaging the second stop mechanism as previously described, to allow the pallet to move downstream along the conveyor 224. Each stenciled pallet may then pass beneath or adjacent yet another rapid dryer (not shown) to lessen the likelihood of image degradation. And afterwards, each fully painted and stenciled pallet is advanced to the exit end of apparatus 10 where it can be manually or automatically removed with a common pallet stacking device.

In use of the aforementioned preferred embodiment, the method for painting and stenciling successive pallets (P1, P2, etc.) starts with positioning a first pallet (P1) onto the front of the paint conveyor 124. If the paint station 20 is not cleared for use, the first pallet is temporarily held from advancing along the paint conveyor chains 126A, 126B, 126C by a pair of side pinch gates 121. Once cleared for advancing, the first pallet P1 is released and sequenced along the conveyor 124 until contacting a first stop mechanism 130-1. Pallet stopping segments 133 of the stop mechanism 130-1 are activated to stop and hold the first pallet P1 when the pallet contacts corresponding dog ears 131 that trigger a proximity sensor. The stop mechanism 130-1 holds the pallet in place long enough for a dual-spray head to travel laterally to the conveyor via a dual-spray head track 140 to spray an undercoat layer onto the vertical front face of that first pallet P1 with a single pass.

After the front face of the first pallet P1 has been painted, the first stop mechanism 130-1 retracts and releases the pallet, i.e. pallet stopping segments 133 rotate forward and downward, and the first pallet moves along the paint conveyor 124 until it contacts a second stop mechanism 130-2. While being stopped and held in similar fashion, the rear vertical side-face of that first pallet P1 is now painted along with the front vertical side-face of the second pallet P2 loaded and sequenced as stated above with reference to the first pallet P1. As previously stated, these painting operations are accomplished simultaneously with a single pass of the dual-spray head along the dual-spray head track 140, but in the reverse or return lateral direction.

The pallet stopping segments 133 of the first and second stop mechanisms 130-1, 130-2 retract and both pallets again advance to their next sequencing operation, i.e. the first pallet P1, now with undercoated front and rear side-faces, passes through painting heads 146 and 148 synchronized to deposit a single paint undercoat layer, near simultaneously, across both the pallet's left and right vertical side-faces, thereby effectively painting an undercoat over all four vertical side-faces of the first pallet P1 that is now reaching the far end of the paint conveyor 124. The second pallet P2 follows behind in like-sequential fashion, as a third P3 and subsequent pallets are loaded into and conveyed through the paint station 20.

Next, the first pallet with painted front, rear and side-faces passes through the transition region 40 from the paint conveyor 124 onto the stenciling conveyor 224 and is conveyed to the dryer station 25. Therein, when the forward edge of the pallet contacts the next sequential stop mechanism 230-1, corresponding pallet stopping segments 133 are raised (as describe above) to again stop and hold it between pairs of forced air blowers 154 positioned along the conveyor 224 to correspond with the four pallet comers for rapidly drying the undercoat layer over which images will next be stenciled.

Assuming the stenciling station 30 is cleared for use, the pallet stopping segments 133 of the stop mechanism 230-1 retract and the painted, dried first pallet P1 is conveyed into the stenciling station where it triggers the stenciling stop mechanism 230-2 as described with the several other upstream stop mechanisms. This last stop mechanism 230-2 is positioned just beyond the end of the stencil station. Substantially simultaneous with the stopping of the pallet by stop mechanism 230-2, a pair of pinch clamps 330, 332 are triggered to move inwardly from opposite sides to firmly hold the first pallet for stenciling. With the movement of both pinch clamps 330, 332, each of the stenciling towers 440, 442, 444, 446 are positioned substantially adjacent and flush with the corner blocks B of the held first pallet P1. Within each stenciling tower 440, 442, 444, 446, a paint sprayer head 462 is activated to move and paint across a corresponding indexed stencil image face 460, thus painting the image on each corner block. Both pinch clamps 330, 332 then release the stenciled first pallet P1 and the stop mechanism 230-2 disengages so allow the pallet to advance to the end of the conveyor where it can be removed and stacked with successive painted and stenciled pallets.

Notably, after several successive pallets have been stenciled by painting through the same stencil face of each tower, all four stenciling towers 440, 442, 444, 446 simultaneously rotate its corresponding stencil positioning wheel 452 downwardly approximately 90° to advance a new stencil image face 460 into position for spraying through. At the same time, the previously used faces are flushed with a high pressure water spray with each pass of the paint sprayer head 462 as previously described. Still further, certain stencil images 460 may warrant further cleaning and/or drying with high pressure air knife 466 after another rotation of the faces about the stencil positioning wheels 452. This is especially true for stencil faces 460 having intricate cutouts that are more prone to clogging with paint and residue.

Obviously, the present invention may be embodied in other specific forms without departing from its spirit or essential characteristics. The described embodiments are to be considered in all respects only as illustrative, not restrictive. The scope of the inventions is, therefore, indicated by the appended claims rather than by the foregoing description and drawings. All changes and/or modifications that come within the meaning and range of equivalency of the claims are to be embraced within their scope.

What is claimed is:

1. An apparatus for painting and stenciling a plurality of pallets, each pallet having a front, rear and opposing side-faces, said apparatus comprising:
(i) a support frame and a conveyor;
(ii) a paint station mounted to said support frame with the conveyor passing therethrough, the paint station having a first pallet sprayer for painting at least one side-face of a first pallet;
(iii) a blower for drying at least one location on the painted face of the first pallet over which a stencil pattern will be painted; and
(iv) a pallet stenciling station that includes:
a stenciling station stop mechanism for holding the painted pallet in the stenciling station;
a stencil positioning wheel for indexing a stencil pattern adjacent the painted side-face of the first pallet; and
a stencil sprayer for painting the indexed stencil pattern on the side-face of the first pallet.

2. The pallet painting and stenciling apparatus of claim 1, wherein the paint station includes two side pallet sprayers, one for each side-face of the pallet to be painted.

3. The pallet painting and stenciling apparatus of claim 1, wherein the paint station further includes an overspray catch basin.

4. The pallet painting and stenciling apparatus of claim 1, wherein the stenciling station stop mechanism includes opposing pinch clamps for holding the pallet during stenciling.

5. The pallet painting and stenciling apparatus of claim 1, wherein the paint station includes a second pallet sprayer for painting the rear face of the first pallet and the front face of a second pallet.

6. The pallet painting and stenciling apparatus of claim 5, wherein the paint station sequentially paints the rear face of the first pallet and the front face of the second pallet while the second pallet sprayer travels in a first lateral direction relative to the conveyor and is then positioned to paint the rear face of the second pallet and the front face of a third pallet while traveling in an opposite lateral direction.

7. The pallet painting and stenciling apparatus of claim 5, wherein the paint station further includes a sensor device for activating and deactivating the second pallet sprayer.

8. The pallet painting and stenciling apparatus of claim 7, wherein the second pallet sprayer includes at least two sprayer outlets and a controller for opening and closing either sprayer outlet relative to the location of the front face of first pallet.

9. The pallet painting and stenciling apparatus of claim 1, wherein the stencil positioning wheel is rotationally indexed to spray through a first pattern for a first set of pallets, then rotate to a pattern cleaning position while a second set of pallets are sprayed through a second pattern.

10. The pallet painting and stenciling apparatus of claim 9, wherein the stencil positioning wheel is rotationally indexed to spray through a third pattern for a third set of pallets while the first pattern is air knifed and the second pattern is rotated to the pattern cleaning position.

11. A pallet stenciling machine, said machine comprising:
a main support frame;
a conveyor attached to the main support frame;
a stenciling station having a stop mechanism for engaging and holding a first pallet at a preferred location; and
a stenciling device for positioning a first stencil image adjacent a side of said first pallet, the stenciling device having a spray gun for painting the first stencil image onto the first pallet before said stop mechanism disengages the first pallet so that said conveyor may transport the stenciled first pallet out of the stenciling station.

12. The pallet stenciling machine of claim 11, wherein the stenciling device includes a stencil wheel that rotationally indexes the first stencil image with the spray gun for painting the first pallet before rotating the first stencil image to a cleaning unit and a second stencil image in line with the spray gun for painting a second pallet.

13. The pallet stenciling machine of claim 12, wherein the stencil wheel can rotationally index a third stencil image in line with the spray gun for painting a third pallet when the first stencil image is rotated to a drying unit using pressurized air and the second stencil image is rotated to the cleaning unit.

14. The pallet stenciling machine of claim 13, wherein the first, second and third stencil images have the same pattern.

15. The pallet stenciling machine of claim 14, wherein the stenciling station stop mechanism includes opposing pinch clamps for holding the pallet relative to the conveyor during stenciling.

16. A method for stenciling at least one image on each of a plurality of pallets, said method comprising:
transporting a first pallet by a conveyor to a stenciling station;
engaging and holding the first pallet at a select position in the stenciling station;
locating a first stencil having an image in line with a spray nozzle at the first position of the held first pallet;
spraying the first stencil image with the nozzle onto a region of said first pallet;
disengaging and releasing the first stenciled pallet on the conveyor for transporting out of the stenciling station;
transporting a following pallet by the conveyor to the stenciling station after the first stenciled pallet exits; and
engaging and holding the following pallet at the select position before repeating the spraying step.

17. The pallet stenciling method of claim 16 which further comprises painting an undercoat on the first pallet before transporting to the stenciling station.

18. The pallet stenciling method of claim 17, wherein the undercoat is painted in a paint station located before the stenciling station, and the undercoat paint is a color that visibly enhances the first stencil image to be sprayed thereover.

19. The pallet stenciling method of claim 18, wherein the undercoat paint is simultaneously sprayed over a rear face of the first pallet and a front face of the following pallet using an undercoat paint sprayer traveling between the first and following pallets in a lateral direction relative to the conveyor.

20. The pallet stenciling method of claim 16 further comprising the step of indexing a second stencil image to the spray nozzle and the first stencil image to a cleaning unit with a stencil rotating device.

21. The pallet stenciling method of claim 20, further comprising the step of indexing a third stencil image to the spray nozzle, the first stencil image to a drying unit and the second stencil image to the cleaning unit with the stencil rotating device.
